(19) United States
(12) Patent Application Publication
(10) Pub. No.: US 2026/0066569 A1
(43) Pub. Date: Mar. 5, 2026

(54) ELECTRICAL CONNECTOR HAVING RIGHT ANGLE CONTACTS

(71) Applicant: TE Connectivity Solutions GmbH, Schaffhausen (CH)

(72) Inventors: Robert Yanos, New Cumberland, PA (US); Jennifer Degrange, Chambersburg, PA (US)

(21) Appl. No.: 18/818,767

(22) Filed: Aug. 29, 2024

(51) Int. Cl. H01R 13/50; H01R 13/11; H01R 13/436; H01R 13/6581

(52) U.S. Cl. CPC H01R 13/501; H01R 13/111; H01R 13/436; H01R 13/6581

(57) ABSTRACT

An electrical connector includes a dielectric housing that extends between a front and a rear. The dielectric housing includes a front contact channel, a rear contact channel, and a forming anvil between the front and rear contact channels. The rear contact channel extends transverse to the front contact channel. The electrical connector includes a contact having a contact body between a mating portion configured to be mated with a mating contact of a mating electrical connector and a terminating portion configured to be terminated to a wire. The mating portion is received in the front contact channel. The contact body has a transition formed along the forming anvil to position the terminating portion in the rear contact channel. The terminating portion is oriented transverse relative to the mating portion.

### BACKGROUND OF THE INVENTION

The subject matter herein relates generally to electrical connectors.

Electrical connectors typically include contacts held in a housing. The contacts are configured to be mated with mating contacts of a mating electrical connector. The connectors typically include cables or wires terminated to ends of the contacts. Some known connectors are right angle connectors having the contacts configured with terminating ends that are 90° to the mating ends to allow the cable to exit the housing 90° relative to the mating axis. The contacts must be carefully bent by a machine or personnel. Improper bending may lead to improper fit in the housing and lead to scrap.

A need remains for an effective and reliable assembly process for electrical connectors having right angle contacts.

### BRIEF DESCRIPTION OF THE INVENTION

In one embodiment, an electrical connector is provided and includes a dielectric housing that extends between a front and a rear. The front configured to be mated with a mating electrical connector. The dielectric housing includes a front contact channel, a rear contact channel, and a forming anvil between the front and rear contact channels. The rear contact channel extends transverse to the front contact channel. The electrical connector includes a contact that includes a contact body between a mating portion and a terminating portion of the contact. The terminating portion is configured to be terminated to a wire. The mating portion is configured to be mated with a mating contact of the mating electrical connector. The mating portion is received in the front contact channel. The contact body has a transition formed along the forming anvil to position the terminating portion in the rear contact channel. The terminating portion is oriented transverse relative to the mating portion.

In another embodiment, an electrical connector is provided and includes a dielectric housing that extends between a front and a rear. The dielectric housing includes a top and a bottom. The dielectric housing includes a first side and a second side. The front forms a mating end of the dielectric housing configured to be mated with a mating electrical connector. The bottom forms a cable end configured to receive a cable. The dielectric housing includes contact channels between the front and the rear. Each contact channel has a front contact channel, a rear contact channel, and a forming anvil between the front and rear contact channels. The rear contact channel extends between the front contact channel and the bottom of the dielectric housing. The electrical connector includes contacts received in the corresponding contact channels. Each contact includes a contact body between a mating portion and a terminating portion of the contact. The terminating portion extends to the cable end and is configured to be terminated to a wire of the cable. The mating portion is configured to be mated with a mating contact of the mating electrical connector. The mating portion is received in the front contact channel. The contact body has a transition formed along the forming anvil to position the terminating portion in the rear contact channel. The terminating portion is oriented transverse relative to the mating portion.

In a further embodiment, an electrical connector is provided and includes a dielectric housing that extends between a front and a rear. The front is configured to be mated with a mating electrical connector. The dielectric housing includes a front contact channel, a rear contact channel, and a forming anvil between the front and rear contact channels. The rear contact channel extends transverse to the front contact channel. The dielectric housing includes a housing cover coupled to the rear of the dielectric housing to cover the rear contact channel. The electrical connector includes an outer shield surrounding at least a portion of the dielectric housing to provide electrical shielding around the dielectric housing. The outer shield includes a shield cover covering the housing cover. The electrical connector includes a contact that includes a contact body between a mating portion and a terminating portion of the contact. The terminating portion is configured to be terminated to a wire. The mating portion configured to be mated with a mating contact of the mating electrical connector. The contact body arranged along the forming anvil to form a transition following the forming anvil by the cover closing the rear contact channel and coupled to the rear of the dielectric housing, wherein the mating portion is received in the front contact channel and the terminating portion is received in the rear contact channel. The terminating portion is oriented transverse relative to the mating portion.

### BRIEF DESCRIPTION OF THE DRAWINGS

FIG. 1 is a perspective view of an electrical connector in accordance with an exemplary embodiment.

FIG. 2 is a front perspective view of the cable assembly in accordance with an exemplary embodiment.

FIG. 3 is a front view of a portion of the cable assembly in accordance with an exemplary embodiment.

FIG. 4 is a rear view of a portion of the cable assembly in accordance with an exemplary embodiment.

FIG. 5 is an exploded view of the cable assembly in accordance with an exemplary embodiment.

FIG. 6 is a rear perspective view of the cable assembly in accordance with an exemplary embodiment showing the housing cover and the shield cover in an open position.

FIG. 7 is a rear perspective view of the cable assembly in accordance with an exemplary embodiment showing the housing cover in the closed position and the shield cover in an open position.

FIG. 8 is a rear view of the cable assembly in accordance with an exemplary embodiment showing the housing cover and the shield cover in an open position.

FIG. 9 is a rear view of the cable assembly in accordance with an exemplary embodiment showing the housing cover in the closed position and the shield cover in an open position.

FIG. 10 is a cross-sectional view of a portion of the cable assembly in accordance with an exemplary embodiment.

FIG. 11 is a rear perspective, partial sectional view of a portion of the cable assembly in accordance with an exemplary embodiment.

### DETAILED DESCRIPTION OF THE INVENTION

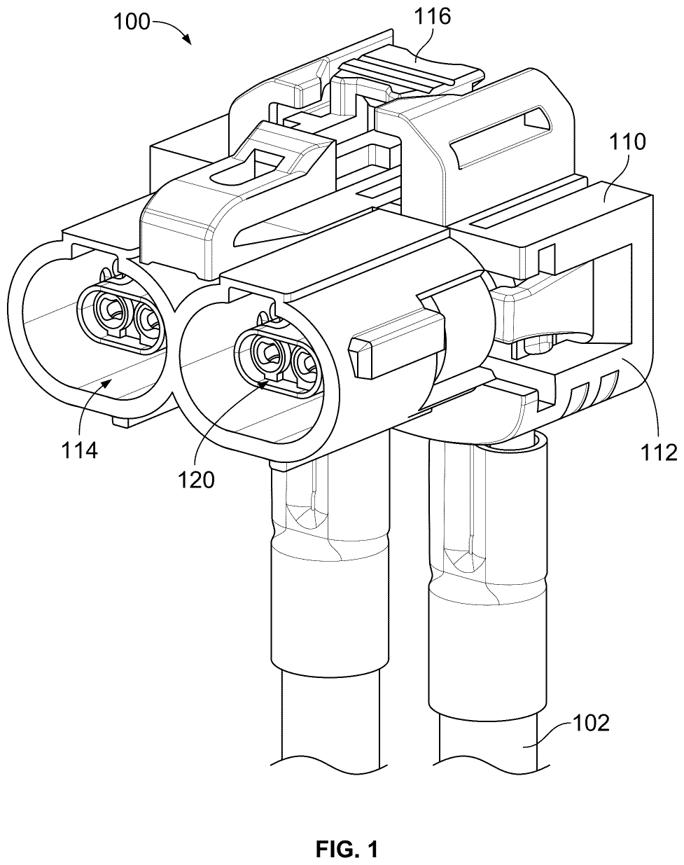

FIG. 1 is a perspective view of an electrical connector 100 in accordance with an exemplary embodiment. The electrical connector 100 is configured to be mated with a mating electrical connector (not shown). In the illustrated embodiment, the electrical connector 100 is a receptacle connector configured to be mated with a plug connector. In alternative embodiments, the electrical connector 100 may be a plug connector configured to be mated with a receptacle connector. In an exemplary embodiment, the electrical connector 100 is a cable connector provided at an end of one or more cables 102. The mating electrical connector may also be a cable connector. Alternatively, the mating electrical connector may be a board connector mounted to a printed circuit board. In various embodiments, the electrical connector 100 may be a header connector configured to be mounted to another component, such as a panel, a wall, a chassis, a circuit board, or another component.

The electrical connector 100 includes a connector housing 110 holding one or more cable assemblies 120. In the illustrated embodiment, the connector housing 110 holds a pair of the cable assemblies 120. However, the connector housing 110 may be designed to hold greater or fewer cable assemblies 120 in alternative embodiments. In the illustrated embodiment, the cable assemblies 120 are arranged side-by-side. Other arrangements are possible in alternative embodiments, such as having the cable assemblies 120 stacked above and below each other.

The connector housing 110 includes walls 112 forming a cavity 114 that receives the cable assemblies 120. The mating electrical connector may be plugged into the cavity 114 to mate with the cable assemblies 120. For example, the connector housing 110 may be open at the front to provide access to the cavity 114 and the cable assemblies 120 to receive the mating electrical connector. The cables 102 extend from the connector housing 110. For example, the cables 102 may extend from the rear of the connector housing 110 and/or the bottom of the connector housing 110. The connector housing 110 includes a latching feature, such as a connector latch 116, used to secure the mating electrical connector in the cavity 114. In the illustrated embodiment, the connector latch 116 is a latch pocket configured to receive a deflectable latch of the mating electrical connector. Other types of latching features may be provided in alternative embodiments, such as a deflectable latch used to electrically coupled to the mating electrical connector. In various embodiments, the connector housing 110 may include guide features and/or keying features to control mating with the mating electrical connector.

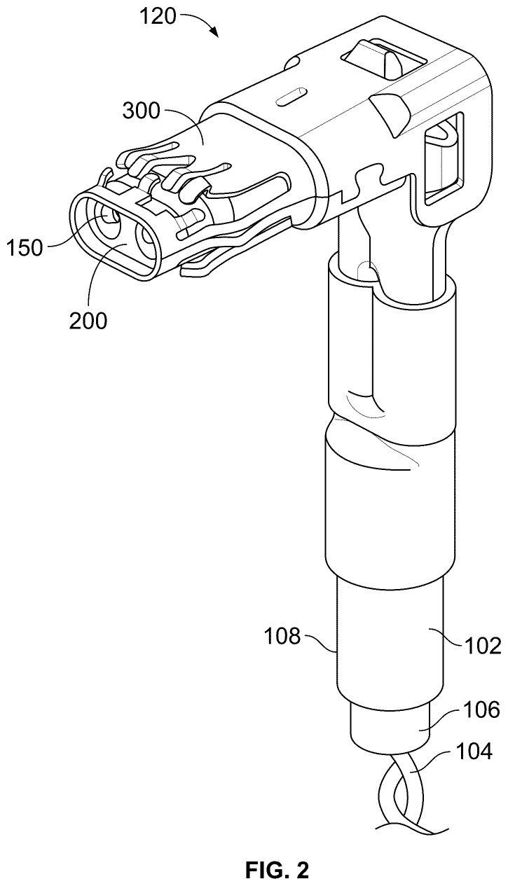

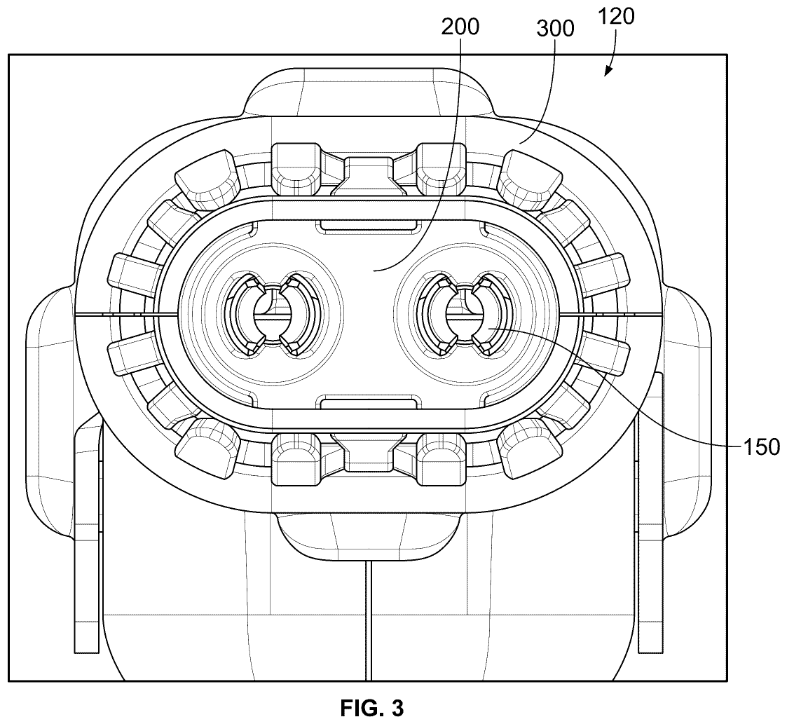

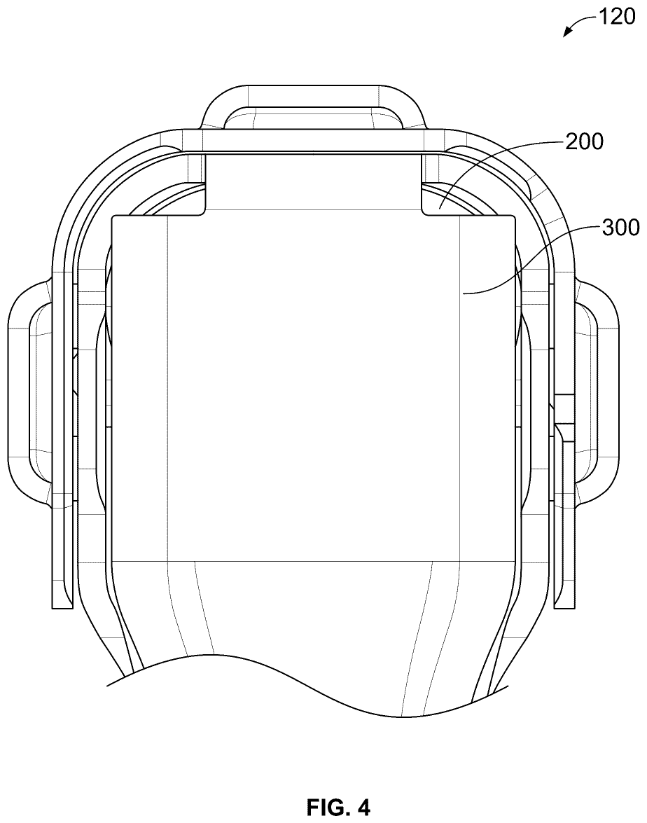

FIG. 2 is a front perspective view of the cable assembly 120 in accordance with an exemplary embodiment. FIG. 3 is a front view of a portion of the cable assembly 120 in accordance with an exemplary embodiment. FIG. 4 is a rear view of a portion of the cable assembly 120 in accordance with an exemplary embodiment. In an exemplary embodiment, the cable assembly 120 is a signal assembly configured to transmit data signals. However, the cable assembly may additionally or alternatively be a power assembly configured to transmit power. In various embodiments, the cable assembly 120 includes multiple signal lines to connect the cable 102 and the mating electrical connector. For example, the cable assembly 120 may include a pair of signal lines configured to convey a differential pair signal. However, the cable assembly 120 may include greater or fewer than two signal lines therethrough. In an exemplary embodiment, the cable assembly 120 is a high-speed cable assembly. For example, the cable assembly 120 may be a multi-gigabit cable assembly. In various embodiments, the cable assembly 120 may provide a bandwidth up to 15 GHz or greater. In various embodiments, the cable assembly 120 may support data transmission up to 56 Gbps or greater.

The cable assembly 120 is terminated to an end of the cable 102. For example, the cable assembly 120 may be terminated to ends of wires 104 of the cable 102. In the illustrated embodiment, the cable 102 includes a differential pair of wires, such as a twisted-pair of the wires 104 or a parallel pair of the wires 104. However, in alternative embodiments, the cable 102 may include greater or fewer wires 104, such as including multiple twisted pairs of the wires 104. In other alternative embodiments, the wires 104 may be single ended wires rather than twisted-pair wires. In other various embodiments, the cable 102 may include a single conductor. In an exemplary embodiment, the cable 102 is a shielded cable having a cable shield 106 surrounding the wires 104 to provide electrical shielding for the wires 104. The cable 102 includes an outer jacket 108 surrounding the cable shield 106.

In an exemplary embodiment, the cable assembly 120 includes one or more contacts 150, a dielectric housing 200 holding the contacts 150, and an outer shield 300 surrounding at least a portion of the dielectric housing 200 to provide electrical shielding around the dielectric housing 200 and the contacts 150 held by the dielectric housing 200. In an exemplary embodiment, the outer shield 300 completely surrounds the dielectric housing 200 and the contacts 150 to provide complete shielding for the contacts 150 between the cable 102 and the mating interface configured to be mated with the mating electrical connector. The outer shield 300 provides 360° shielding around the end of the cable 102 and the contacts 150. For example, the outer shield 300 provides shielding along the top, the bottom, the sides, the front, and the rear of the cable assembly 120 to provide efficient electrical shielding along the signal transmission lines.

In the illustrated embodiment, the cable assembly 120 includes a pair of the contacts 150. The contacts 150 are configured to be terminated to the ends of the corresponding wires 104 of the cable 102. The outer shield 300 is configured to be terminated to the cable shield 106 of the cable 102, either directly or through a ferrule or other connecting element, to create a common ground path between the cable 102 and the cable assembly 120.

In an exemplary embodiment, the cable assembly 120 is a right-angle cable assembly. The contacts 150 are right angle contacts having a 90° bend along the contacts 150 to transition between the mating ends of the terminating ends of the contacts 150. In the illustrated embodiment, the cable 102 extends from the bottom of the cable assembly 120. The cable 102 generally extends along a cable axis that is perpendicular to the mating axis of the cable assembly 120. The cable 102 may extend from other portions of the cable assembly 120, such as the side or the top in alternative embodiments. The cable 102 may extend at other angles other than a right angle in alternative embodiments.

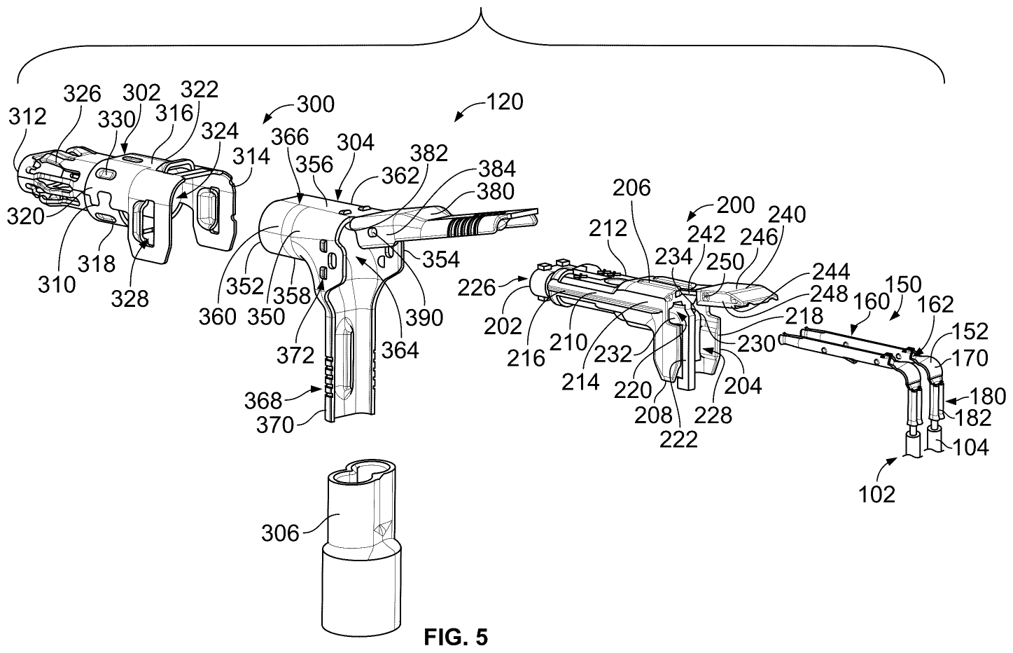

FIG. 5 is an exploded view of the cable assembly 120 in accordance with an exemplary embodiment. FIG. 5 shows the contacts 150, the dielectric housing 200, and the outer shield 300. In the illustrated embodiment, the outer shield 300 is a multi-piece shield having a front shield 302, a rear shield 304, and a ferrule 306 for the cable 102 configured to be coupled to the rear shield 304 to mechanically and electrically connect the cable 102 to the outer shield 300. The rear shield 304 is separate and discrete from the front shield 302 and configured to be electrically coupled to the front shield 302, such as by crimping, laser welding, or other connecting process. However, in alternative embodiments, the outer shield 300 may be a single piece shield rather than the multi-piece shield.

Each contact 150 includes a contact body 152 extending between a mating portion 160 and a terminating portion 180. In an exemplary embodiment, the contact body 152 is a stamped and formed structure stamped from a metal sheet and formed into a desired shape. For example, the contact body 152 is a unitary structure having the mating portion 160 integral with the terminating portion 180.

The mating portion 160 is configured to be mated with a mating contact of the mating electrical connector. In the illustrated embodiment, the mating portion 160 includes a socket 162 configured to receive a pin defining the mating contact of the mating electrical connector. Other types of mating portions may be provided in alternative embodiments, such as a pin, a spring beam, a blade, or another type of mating portion. In an exemplary embodiment, the mating portion 160 is formed into a cylindrical or tubular structure to define the socket 162. The mating portion 160 may have other shapes in alternative embodiments.

The terminating portion 180 is configured to be terminated to the wire 104 of the cable 102. In the illustrated embodiment, the terminating portion 180 includes a crimp barrel 182 configured to be crimped to the wire 104. Other types of terminating portions may be provided in alternative embodiments, such as a weld pad or solder pad configured to be welded or soldered to the wire 104, or an insulation displacement contact.

In an exemplary embodiment, the contact body 152 includes a transition 170 between the mating portion 160 and a terminating portion 180. The transition 170 includes a bend or fold that orients the terminating portion 180 transverse relative to the mating portion 160. For example, the transition 170 may have a 90° bend to form a right-angle contact. In the illustrated embodiment, the terminating portion 180 is oriented perpendicular to the mating portion 160. For example, the mating portion 160 is oriented generally horizontally and the terminating portion 180 is oriented generally vertically.

The dielectric housing 200 is used to hold the contacts 150 relative to each other, such as for mating with the mating electrical connector. The dielectric housing 200 is manufactured from a dielectric material, such as a plastic material. In an exemplary embodiment, the dielectric housing 200 is manufactured by a molding process, such as an injection molding process. The dielectric housing 200 extends between a front 202 and a rear 204. The dielectric housing 200 includes a top 206 and a bottom 208. The dielectric housing 200 includes a first side 210 and a second side 212. In an exemplary embodiment, the dielectric housing 200 includes a base 214, a front portion 216 extending forward from the base 214, and a rear portion 218 extending rearward from the base 214. In an exemplary embodiment, the front portion 216 receives and supports the mating portions 160 of the contacts 150 and the rear portion 218 receives and supports the terminating portions 180 of the contacts 150. The front portion 216 may define a nose cone at the front 202 of the dielectric housing 200 configured to surround and support the mating portions 160 of the contacts 150. The rear portion 218 may define a platform or tray configured to support the terminating portions 180 of the contacts 150.

In an exemplary embodiment, the dielectric housing 200 includes contact channels 220 configured to receive the corresponding contacts 150. The dielectric housing 200 may include multiple contact channels 220 or a single contact channel 220 depending on the particular application. In the illustrated embodiment, the dielectric housing 200 includes a pair of the contact channels 220 to receive the pair of the contacts 150. Greater or fewer contact channels 220 may be provided in alternative embodiments. In an exemplary embodiment, the contact channels 220 are arranged in a row between the first side 210 and the second side 212. For example, the contact channels 220 are arranged side-by-side with a separating wall 222 between the contact channels 220. The separating wall 222 is a contact separator between the contacts. The separating wall 222 may be a wire separator between the wires. The separating wall 222 electrically isolates the contacts 150 from each other within the contact channels 220.

In an exemplary embodiment, each contact channel 220 includes a front contact channel 226 and a rear contact channel 228. The front contact channel 226 passes through the front portion 216 and receives the mating portion 160 of the corresponding contact 150. The rear contact channel 228 passes through the rear portion 218 and receives the terminating portion 180 of the corresponding contact 150. The rear contact channel 228 extends along a path transverse to the path of the front contact channel 226. For example, in the illustrated embodiment, the rear contact channel 228 is oriented generally perpendicular to the front contact channel 226. The rear contact channel 228 may be oriented at other angles in alternative embodiments.

In an exemplary embodiment, each contact channel 220 includes a forming anvil 230 between the front and rear contact channels 226, 228. The forming anvil 230 is at the intersection between the front and rear contact channels 226, 228. The forming anvil 230 is defined by an interior corner 232 of the contact channel 220. In an exemplary embodiment, the forming anvil 230 is curved following an arcuate path. In an exemplary embodiment, the forming anvil 230 includes a forming surface 234 used to form the transition 170 of the contact 150. For example, the body of the contact 150 may be formed on the forming anvil 230 by bending the body of the contact 150 against the forming surface 234 to form the transition 170. The smooth curved profile of the forming anvil 230 provides a supporting surface for forming the bend or curved portion of the transition 170 of the contact 150.

In an exemplary embodiment, the front contact channel 226 is completely surrounded by the dielectric housing 200. For example, the front contact channel 226 may be a generally cylindrical tube or bore passing through the front portion 216 of the dielectric housing 200 with the dielectric housing 200 providing 360° covering around the front contact channel 226 along the entire length of the front contact channel 226. However, the front contact channel 226 may include openings providing access to the front contact channel 226 in various embodiments. In an exemplary embodiment, the contact 150 may be rear loaded into the front contact channel 226 through the rear 204 of the dielectric housing 200.

In an exemplary embodiment, the rear contact channel 228 is open at the rear 204 of the dielectric housing 200. For example, the rear contact channel 228 may be surrounded on three sides by the dielectric housing 200, such as the front, the right side, and left side of the rear contact channel 228, but the rear of the rear contact channel 228 may be open. The rear contact channel 228 is open at the rear to receive the contact 150.

In an exemplary embodiment, the dielectric housing 200 includes a housing cover 240 at the rear 204. The housing cover 240 is configured to be coupled to the rear 204 to close the rear contact channel 228. The housing cover 240 is used to cover the terminating ends 180 of the contacts 150 and the rear contact channels 220. In an exemplary embodiment, the housing cover 240 is connected to the base 214 of the dielectric housing 200 by a hinge 242. In an exemplary embodiment, the hinge 242 and the housing cover 240 are integral with the dielectric housing 200. For example, the dielectric housing 200, the hinge 242, and the housing cover 240 may be co-molded during a common molding process to form a unitary, monolithic structure. The hinge 242 may be a living hinge. In the illustrated embodiment, the hinge 242 is located at the top 206 of the dielectric housing 200. The housing cover 240 is supported at the top 206 of the dielectric housing 200 and is configured to be closed by rotating the housing cover 240 downward to connect the housing cover 240 to the rear 204 of the dielectric housing 200. Other mounting locations and closing processes may be utilized in alternative embodiments.

The housing cover 240 includes an interior surface 244 and an exterior surface 246 with side walls 248 therebetween. The housing cover 240 may include supporting features 250 along the side walls 248 to support the housing cover 240 and the dielectric housing 200. The supporting features 250 may be protrusions, bumps, tabs, rails, grooves, slots, or other features formed in or protruding from the side walls 248 configured to interface with complementary features at the rear 204 the dielectric housing 200. The supporting features 250 may be used to position and/or guide the housing cover 240 relative to the dielectric housing 200. The supporting features 250 may secure the housing cover 240 to the dielectric housing 200, such as by an interference fit or a latch type connection.

When the housing cover 240 is closed, the interior surface 244 faces the rear contact channels 220. The interior surface 244 supports the terminating ends 180 of the contacts 150 and the rear contact channel 228. In an exemplary embodiment, the housing cover 240 may be used to form the contacts 150 during assembly. For example, as the housing cover 240 is moved from the open position to a closed position, the housing cover 240 may engage the terminating ends 180 of the contacts 150 (for example, when in a straight or pre-bent configuration) and bend the contacts 150 to form the transitions 170 during the closing of the housing cover 240. The transitions 170 are bent around the forming anvils 230 as the housing cover 240 is closed. Alternatively, the contacts 150 may be bent around the forming anvils 230 by hand or using a tool prior to closing the housing cover 240.

The outer shield 300 provides shielding for the contacts 150. The dielectric housing 200 positions the contacts 150 relative to the outer shield 300 and is used to electrically isolate the contacts 150 from the outer shield 300. In the illustrated embodiment, the outer shield 300 includes the front shield 302 and the rear shield 304. The front shield 302 extends along and provides shielding for the front portion 216 of the dielectric housing 200. The rear shield 304 extends along and provides shielding for the rear portion 218 of the dielectric housing 200.

In an exemplary embodiment, the front shield 302 is a stamped and formed part stamped from a metal sheet and formed into a desired shape. The front shield 302 includes a shield body 310 stamped from the metal sheet. The front shield 302 extends between a front 312 and a rear 314. The front shield 302 includes a top 316 and a bottom 318. The front shield 302 includes a first side 320 and a second side 322. The front shield 302 includes a cavity 324 surrounded by the shield body 310. In the illustrated embodiment, the cavity 324 is open at the front 312 and the rear 314. The opening at the front 312 provides access to the dielectric housing 200 and the mating portions 160 of the contacts 150 for mating with the mating electrical connector. The opening at the rear 314 allows rear loading of the rear shield 304 and the dielectric housing 200 into the cavity 324.

In an exemplary embodiment, the front shield 302 includes connecting beams 326 proximate to the front 312. The connecting beams 326 are configured to be electrically connected to a shield structure of the mating electrical connector to create a ground path between the outer shield 300 and the mating electrical connector.

In an exemplary embodiment, the front shield 302 includes securing elements 328 used to secure the outer shield 300 to the connector housing 110 (shown in FIG. 1). In the illustrated embodiment, the securing elements 328 are defined by latches extending outward from the front shield 302, such as at the top 316, the first side 320 and the second side 322. The securing elements 328 are located near the rear 314. Other locations are possible in alternative embodiments. Other types of securing elements may be used in alternative embodiments.

In an exemplary embodiment, the front shield 302 includes commoning elements 330 used to electrically common the front shield 302 to the rear shield 304. In the illustrated embodiment, the commoning elements 330 include interference bumps or dimples extending inward into the cavity 324 to interface with the rear shield 304 when the rear shield 304 is plugged into the cavity 324. Other types of commoning elements may be used in alternative embodiments to electrically connect the front shield 302 and the rear shield 304. Optionally, the front shield 302 may be soldered or welded to the rear shield 304 during assembly.

In an exemplary embodiment, the rear shield 304 is a stamped and formed part stamped from a metal sheet and formed into a desired shape. The rear shield 304 includes a shield body 350 stamped from the metal sheet. The rear shield 304 extends between a front 352 and a rear 354. The rear shield 304 includes a top 356 and a bottom 358. The rear shield 304 includes a first side 360 and a second side 362. The rear shield 304 includes a cavity 364 surrounded by the shield body 350. In the illustrated embodiment, the cavity 364 is open at the front 352 and the rear 354. The opening at the front 352 allows the front portion 216 of the dielectric housing 200 to pass through the rear shield 304. The opening at the rear 354 allows rear loading of the dielectric housing 200 into the cavity 364.

In an exemplary embodiment, the cavity 364 includes a main portion 366 and a cable portion 368 extending from the main portion 366. The cable portion 368 is defined by a front wall 370. The main portion 366 is configured to receive the front portion 216 of the dielectric housing 200. The cable portion 368 is configured to receive the rear portion 218 of the dielectric housing 200 and a portion of the cable 102 (shown in FIG. 1). In an exemplary embodiment, the cable portion 368 is configured to be terminated to the cable shield 106 of the cable 102. For example, the cable portion 368 may be crimped, soldered, welded, or otherwise terminated to the cable shield 106.

In the illustrated embodiment, the cable portion 368 extends transverse to the main portion 366. In various embodiments, the cable portion 368 may be oriented perpendicular to the main portion 366. For example, the main portion 366 may extend generally horizontally and the cable portion 368 may extend generally vertically. Other orientations are possible in alternative embodiments. In the illustrated embodiment, the front wall 370 is oriented vertically. Other orientations are possible in alternative embodiments. The front wall 370 may be curved, such as to match a curvature of the cable 102.

In an exemplary embodiment, the rear shield 304 includes securing features 372 along the main portion 366, such as along the side walls and/or the top wall. The securing features 372 may be protrusions, bumps, tabs, latches, rails, grooves, slots, or other features formed in or protruding from the walls configured to interface with complementary features at the rear of the front shield 302. The securing features 372 may be used to position and/or guide the rear shield 304 relative to the front shield 302 during assembly. The securing features 372 are used to secure the rear shield 304 to the front shield 302, such as by an interference fit or a latch type connection.

In an exemplary embodiment, the rear shield 304 includes a shield cover 380 at the rear 354. The shield cover 380 is configured to be coupled to the rear 354 to close the cavity 364. The shield cover 380 is used to cover the rear of the dielectric housing 200, such as the housing cover 240, when the shield cover 380 is closed. In an exemplary embodiment, the shield cover 380 is connected to the rear shield 304 by a hinge 382. In an exemplary embodiment, the hinge 382 and the shield cover 380 are integral with the rear shield 304. For example, the rear shield 304, the hinge 382, and the shield cover 380 may be stamped and formed from a common metal sheet as a unitary, monolithic structure. The hinge 382 may be a living hinge. In the illustrated embodiment, the hinge 382 is located at the top 356 of the rear shield 304. The shield cover 380 is supported at the top 356 of the rear shield 304 and is configured to be closed by rotating the shield cover 380 downward to connect the shield cover 380 to the rear 354 of the rear shield 304. Other mounting locations and closing processes may be utilized in alternative embodiments.

The shield cover 380 includes a rear cover wall 384 used to cover and close the cavity 364. The shield cover 380 may include securing features 390 along the rear cover wall 384 to secure the shield cover 380 to the rear shield 304. The securing features 390 may be protrusions, bumps, tabs, rails, grooves, slots, or other features formed in or protruding from the rear cover wall 384 configured to interface with complementary features at the rear 354 of the rear shield 304. The securing features 390 may be used to position and/or guide the shield cover 380 relative to the rear shield 304. The securing features 390 may secure the shield cover 380 to the rear shield 304, such as by an interference fit or a latch type connection.

When the shield cover 380 is closed, rear cover wall 384 faces the front wall 370 to form a pocket that receives the end of the cable 102 and/or the wires 104. The shield cover 380 supports the dielectric housing 200 in the cavity 364. For example, the shield cover 380 prevents removal of the dielectric housing 200 when closed. The shield cover 380 provides shielding along the rear of the dielectric housing 200 and the contacts 150.

In an exemplary embodiment, the shield cover 380 may be used to form the contacts 150 during assembly. For example, as the shield cover 380 is moved from the open position to a closed position, the shield cover 380 may engage the housing cover 240 to automatically close the housing cover 240 as the shield cover 380 is closed. Such closing action may press the housing cover 240 against the terminating ends 180 of the contacts 150 (for example, when in a straight or pre-bent configuration) and bend the contacts 150 to form the transitions 170 during the closing of the housing cover 240 with the shield cover 380. The transitions 170 are bent around the forming anvils 230 as the shield cover 380 is closed. Alternatively, the contacts 150 may be bent around the forming anvils 230 by hand or using a tool prior to closing the shield cover 380. The housing cover 240 may be closed prior to closing the shield cover 380.

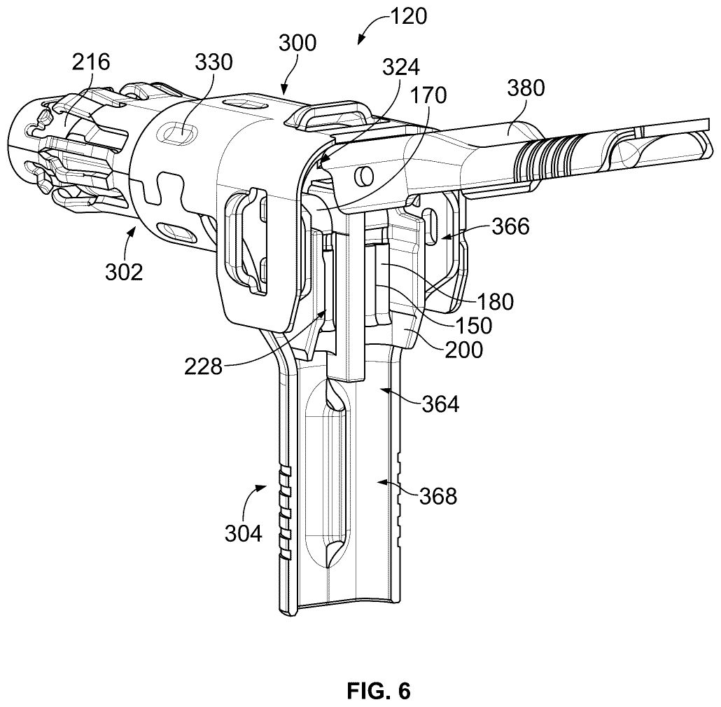

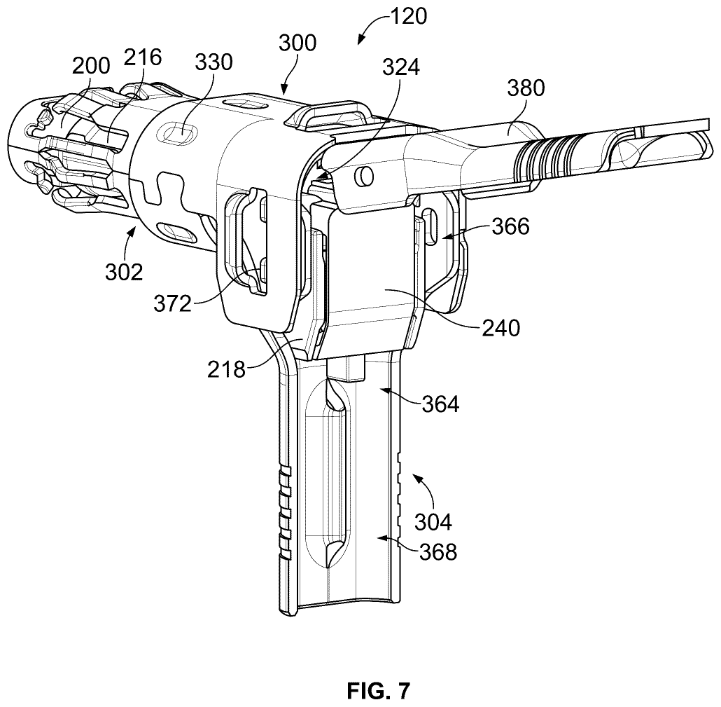

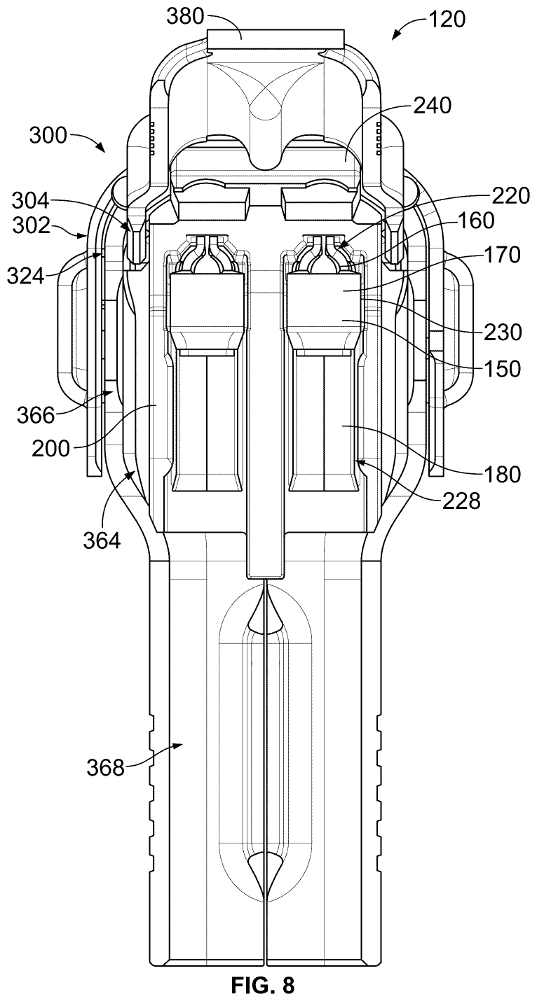

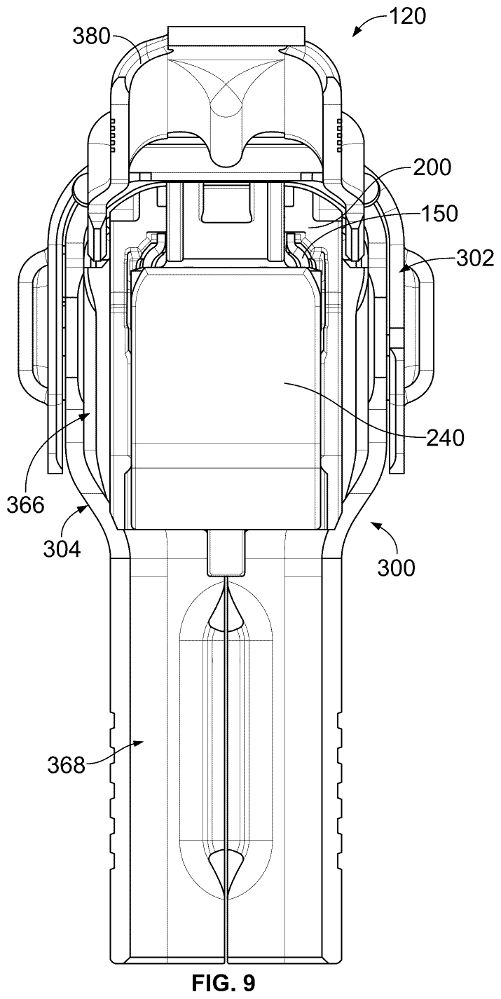

FIG. 6 is a rear perspective view of the cable assembly 120 in accordance with an exemplary embodiment showing the housing cover 240 and the shield cover 380 in an open position. FIG. 7 is a rear perspective view of the cable assembly 120 in accordance with an exemplary embodiment showing the housing cover 240 in the closed position and the shield cover 380 in an open position. FIG. 8 is a rear view of the cable assembly 120 in accordance with an exemplary embodiment showing the housing cover 240 and the shield cover 380 in an open position. FIG. 9 is a rear view of the cable assembly 120 in accordance with an exemplary embodiment showing the housing cover 240 in the closed position and the shield cover 380 in an open position.

During assembly, the contacts 150 are loaded into the contact channels 220 of the dielectric housing 200. In various embodiments, the contacts 150 may be preformed into right angle contacts prior to loading the contacts 150 into the contact channels 220. In alternative embodiments, the contacts 150 may be formed into right angle contacts after loading the contacts 150 into the contact channels 220. For example, the contacts 150 may be formed against the forming anvil 230 after the contacts 150 are loaded into the contact channels 220. For example, after the mating portion 160 is loaded into the front portion 216 of the contact channel 220, the terminating portion 180 may be bent downward into the rear contact channel 228 of the contact channel 220 to form the transition 170 between the mating portion 160 and the terminating portion 180. The terminating portion 180 may be bent downward by hand or using a tool or fixturing device during the assembly process. In other various embodiments, the terminating portion 180 may be bent downward by the housing cover 240 as the housing cover 240 is moved from the open position to the closed position. For example, the inner surface of the housing cover 240 may press against the terminating portion 180 of the contact 150 to bend the contact 150 at the transition 170 and load the terminating portion 180 into the rear contact channel 228.

During assembly, the outer shield 300 is assembled by plugging the rear shield 304 into the cavity 324 of the front shield 302. The securing features 372 are secured to the front shield 302 to secure the rear shield 304 to the front shield 302. The commoning elements 330 of the front shield 302 are used to electrically common the front shield 302 to the rear shield 304. For example, the commoning elements 330 engage the main portion 366 by an interference fit. Optionally, the commoning elements 330 may be soldered or welded to the rear shield 304 during assembly, such as by a laser welding process.

During assembly, the dielectric housing 200 is loaded into the outer shield 300. The contacts 150 may be preloaded into the dielectric housing 200 prior to loading the dielectric housing 200 into the outer shield 300. Alternatively, the contacts 150 may be loaded into the dielectric housing 200 after the dielectric housing 200 is loaded into the outer shield 300. The wires 104 (shown in FIG. 1) may be terminated to the terminating portions 180 of the contacts 150 prior to loading the contacts 150 into the dielectric housing 200. The wires 104 configured to extend through the cable portion 368 of the cavity 364 of the rear shield 304 after the terminating portions 180 are bent downward into the 90° configuration. In various embodiments, the housing cover 240 may be closed prior to loading the dielectric housing 200 into the outer shield 300. Alternatively, the housing cover 240 may be closed after the dielectric housing 200 is loaded into the outer shield 300. In various embodiments, the shield cover 380 may be used to close the housing cover 240. For example, movement of the shield cover 380 from the open position to the closed position may automatically close the housing cover 240. Optionally, if the contacts 150 are in the straight configuration (rather than the right-angle configuration), the closing of the shield cover 380 may be used to form the contacts 150 into the right angle configuration. For example, the closing of the shield cover 380 may cause closing of the housing cover 240 to compress the terminating portions 180 of the contacts 150 downward to form the transitions 170 of the contacts 150 against the forming anvil 230. After the shield cover 380 is closed, the outer shield 300 provides 360° circumferential shielding for the contacts 150. After the shield cover 380 is closed, the rear shield 304 may be terminated to the cable 102, such as being cramped, welded, or soldered to the cable shield 106 of the cable 102.

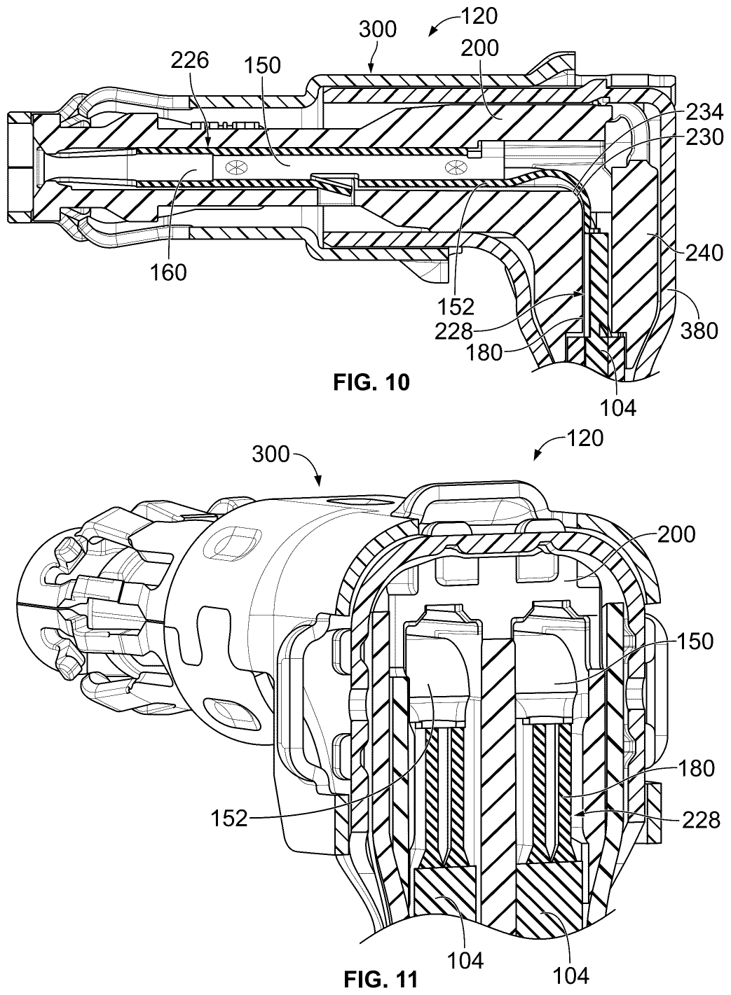

FIG. 10 is a cross-sectional view of a portion of the cable assembly 120 in accordance with an exemplary embodiment. FIG. 11 is a rear perspective, partial sectional view of a portion of the cable assembly 120 in accordance with an exemplary embodiment. FIGS. 10 and 11 show the cable assembly 120 in an assembled position showing the contacts 150 received in the dielectric housing 200 and showing the dielectric housing 200 received in the outer shield 300. The wires 104 are shown terminated to the terminating portions 180 of the contacts 150. The contacts 150 are shown in the right-angle configuration having the terminating portions 180 oriented perpendicular to the mating portions 160. The transitions 170 form a 90° bend between the mating portions 160 and the terminating portions 180. The forming anvils 230 support the transitions 170. In an exemplary embodiment, the transitions 170 may be formed against the forming surfaces 234 of the forming anvils 230 by bending the contact bodies 152 of the contacts 150 around the curved surfaces of the forming anvils 230. For example, the contacts 150 may be formed in place in the dielectric housing 200 to ensure proper fit of the mating portions 160 in the front contact channels 226 and the terminating portions 180 and the rear contact channels 228. The housing cover 240 holds the contacts 150 in the contact channels 220. The housing cover 240 electrically isolates the contacts 150 from the shield cover 380.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. An electrical connector comprising:
a dielectric housing extending between a front and a rear, the front configured to be mated with a mating electrical connector, the dielectric housing including a front contact channel, a rear contact channel, and a forming anvil between the front and rear contact channels, the rear contact channel extending transverse to the front contact channel; and
a contact including a contact body between a mating portion and a terminating portion of the contact, the terminating portion configured to be terminated to a wire, the mating portion configured to be mated with a mating contact of the mating electrical connector, the mating portion received in the front contact channel, the contact body having a transition formed along the forming anvil to position the terminating portion in the rear contact channel, the terminating portion oriented transverse relative to the mating portion.

2. The electrical connector of claim 1, wherein the transition follows an arcuate path.

3. The electrical connector of claim 1, wherein the forming anvil includes a forming surface, the transition being formed on the forming surface.

4. The electrical connector of claim 1, wherein the terminating portion is moved into the rear contact channel after the mating portion is received in the front contact channel.

5. The electrical connector of claim 1, wherein the rear contact channel is oriented perpendicular to the front contact channel.

6. The electrical connector of claim 1, wherein the dielectric housing includes a housing cover at the rear of the dielectric housing to cover the contact in the rear contact channel, the housing cover movable between an open position and a closed position.

7. The electrical connector of claim 6, wherein the housing cover is configured to press against the terminating portion of the contact to form the transition as the housing cover is moved from the open position to the closed position.

8. The electrical connector of claim 6, wherein the housing cover includes a contact pocket receiving the terminating portion of the contact.

9. The electrical connector of claim 6, wherein the housing cover is connected to the dielectric housing by a hinge, the housing cover rotated by the hinge between the open position in the closed position.

10. The electrical connector of claim 6, wherein the housing cover is integral with the dielectric housing being a monolithic, unitary structure.

11. The electrical connector of claim 6, further comprising an outer shield surrounding at least a portion of the dielectric housing to provide electrical shielding around the dielectric housing, the outer shield including a shield cover covering the housing cover.

12. The electrical connector of claim 11, wherein the shield cover is movable between an open position and a closed position, the shield cover configured to move the housing cover from the open position to the closed position as the shield cover is moved from the open position to the closed position.

13. The electrical connector of claim 1, further comprising an outer shield surrounding at least a portion of the dielectric housing to provide electrical shielding around the dielectric housing.

14. The electrical connector of claim 13, wherein the outer shield includes a front shield and the rear shield separate and discrete from the front shield and configured to be electrically coupled to the front shield, the front shield including a front cavity receiving the front of the dielectric housing, the rear shield including a rear cavity receiving the rear of the dielectric housing.

15. An electrical connector comprising:
a dielectric housing extending between a front and a rear, the dielectric housing including a top and a bottom, the dielectric housing including a first side and a second side, the front forming a mating end of the dielectric housing configured to be mated with a mating electrical connector, the bottom forming a cable end configured to receive a cable, the dielectric housing including contact channels between the front and the rear, each contact channel having a front contact channel, a rear contact channel, and a forming anvil between the front and rear contact channels, the rear contact channel extending between the front contact channel and the bottom of the dielectric housing; and
contacts received in the corresponding contact channels, the each contact including a contact body between a mating portion and a terminating portion of the contact, the terminating portion extending to the cable end and configured to be terminated to a wire of the cable, the mating portion configured to be mated with a mating contact of the mating electrical connector, the mating portion received in the front contact channel, the contact body having a transition formed along the forming anvil to position the terminating portion in the rear contact channel, the terminating portion oriented transverse relative to the mating portion.

16. The electrical connector of claim 15, wherein the contact channels are aligned in a row between the first and second sides, the contact channels separated by separating walls.

17. The electrical connector of claim 15, wherein the terminating portion is moved into the rear contact channel after the mating portion is received in the front contact channel.

18. The electrical connector of claim 15, wherein the dielectric housing includes a housing cover at the rear of the dielectric housing to cover the contact in the rear contact channel, the housing cover movable between an open position and a closed position, wherein the housing cover is configured to press against the terminating portion of the contact to form the transition as the housing cover is moved from the open position to the closed position.

19. The electrical connector of claim 18, further comprising an outer shield surrounding at least a portion of the dielectric housing to provide electrical shielding around the dielectric housing, the outer shield including a shield cover covering the housing cover, the shield cover being movable between an open position and a closed position, the shield cover configured to move the housing cover from the open position to the closed position as the shield cover is moved from the open position to the closed position.

20. An electrical connector comprising:
a dielectric housing extending between a front and a rear, the front configured to be mated with a mating electrical connector, the dielectric housing including a front contact channel, a rear contact channel, and a forming anvil between the front and rear contact channels, the rear contact channel extending transverse to the front contact channel, the dielectric housing including a housing cover coupled to the rear of the dielectric housing to cover the rear contact channel;
an outer shield surrounding at least a portion of the dielectric housing to provide electrical shielding around the dielectric housing, the outer shield including a shield cover covering the housing cover; and
a contact including a contact body between a mating portion and a terminating portion of the contact, the terminating portion configured to be terminated to a wire, the mating portion configured to be mated with a mating contact of the mating electrical connector, the contact body arranged along the forming anvil to form a transition following the forming anvil by the cover closing the rear contact channel and coupled to the rear of the dielectric housing, wherein the mating portion is received in the front contact channel and the terminating portion is received in the rear contact channel, the terminating portion being oriented transverse relative to the mating portion.
